(19) United States
(12) Patent Application Publication
(10) Pub. No.: US 2022/0099908 A1
(43) Pub. Date: Mar. 31, 2022

(54) OPTICAL UNIT

(71) Applicant: NIDEC SANKYO CORPORATION, Nagano (JP)

(72) Inventors: Takeshi SUE, Nagano (JP); Shinji MINAMISAWA, Nagano (JP); Tsutomu ARAI, Nagano (JP)

(73) Assignee: NIDEC SANKYO CORPORATION, Nagano (JP)

(21) Appl. No.: 17/489,715

(22) Filed: Sep. 29, 2021

(30) Foreign Application Priority Data
Sep. 30, 2020 (JP) 2020-164665

(51) Int. Cl. G02B 7/02

(52) U.S. Cl. CPC G02B 7/02

(57) ABSTRACT

The disclosure provides an optical unit including a movable body including an optical module, a fixed body, and correction mechanisms for correcting the optical axis direction by changing the arrangement of the movable body with respect to the fixed body. An optical unit includes a movable body including an optical module, a fixed body surrounding the movable body in peripheral directions intersecting the optical axis direction of the optical module, and correction mechanisms that correct the arrangement of the movable body with respect to the fixed body. The correction mechanisms include a tilt mechanism that swingably supports the movable body with respect to the fixed body in directions intersecting the optical axis direction as rotation axes, and shift mechanism that movably supports the movable body with respect to the fixed body with the directions intersecting the optical axis direction.

### CROSS-REFERENCE TO RELATED APPLICATIONS

The present invention claims priority under 35 U.S.C. § 119 to Japanese Application No. 2020-164665, filed on Sep. 30, 2020, the entire content of which is incorporated hereby by reference.

### BACKGROUND

### Field of the Invention

The disclosure relates to an optical unit.

### Background

Conventionally, a variety of optical units have been used. Among them, optical units having correction mechanisms for correcting the optical axis direction by changing the arrangement of a movable body having an optical module with respect to a fixed body have been used. For example, Patent Literature 1 discloses a lens driving device capable of moving a lens support including a lens with respect to a first plate.

### RELATED ART

### Patent Literature

[Patent Literature 1] Japanese Unexamined Patent Publication No. 2020-52415

In an optical unit provided with a correction mechanism for correcting the optical axis direction by changing the arrangement of the movable body including the optical module with respect to the fixed body as described above, it has been difficult to increase the amount of correction of the movable body with respect to the fixed body while keeping the optical unit small. This is because even if the movable body is tilted with respect to the fixed body, the angle that is able to be tilted is often limited; also, if the angle at which the movable body is tilted with respect to the fixed body is increased, the fixed body will need to have a large space that allows the movable body to rotate in the directions intersecting the rotation axis. Further, in the configuration in which the movable body is shifted in the linear direction with respect to the fixed body, the amount of correction in the optical axis direction is limited. Therefore, an object of the disclosure is to increase the amount of correction in the optical axis direction while keeping the size small in the optical unit including a movable body including an optical module, a fixed body, and correction mechanisms for correcting the optical axis direction by changing the arrangement of the movable body with respect to the fixed body.

### SUMMARY

The optical unit of the disclosure includes a movable body including an optical module, a fixed body surrounding the movable body in peripheral directions intersecting an optical axis direction of the optical module, and correction mechanisms that correct the optical axis direction by changing an arrangement of the movable body with respect to the fixed body. The correction mechanisms include a tilt mechanism that swingably supports the movable body with respect to the fixed body with a direction intersecting the optical axis direction as a rotation axis, and a shift mechanism that movably supports the movable body with respect to the fixed body in the direction intersecting the optical axis direction.

### BRIEF DESCRIPTION OF THE DRAWINGS

FIG. 1 is an exploded perspective view of an optical unit according to Embodiment 1 of the disclosure.

FIG. 2 is a side sectional view of an optical unit according to Embodiment 1 of the disclosure.

FIG. 3 is an exploded perspective view of an optical unit according to Embodiment 2 of the disclosure.

FIG. 4 is a side sectional view of an optical unit according to Embodiment 2 of the disclosure.

### DESCRIPTION OF THE EMBODIMENTS

Hereinafter, embodiments of the disclosure will be described with reference to the drawings. The same configuration in each embodiment is indicated by the same reference numerals and will be described only in the first embodiment, and the description of the configuration will be omitted in the subsequent embodiments. In each drawing, the X-axis, the Y-axis, and the Z-axis are orthogonal to each other. The views seen in the +X and −X directions are side views; the view seen in the +Y direction is a front view; the view seen in the −Y direction is a rear view; the view seen in the +Z direction is a plan view; and the view seen in the −Z direction is a bottom view. Further, the X-axis direction corresponds to the yawing axis direction, the Y-axis direction corresponds to the pitching axis direction, and the Z-axis direction corresponds to the optical axis direction and the rolling axis direction.

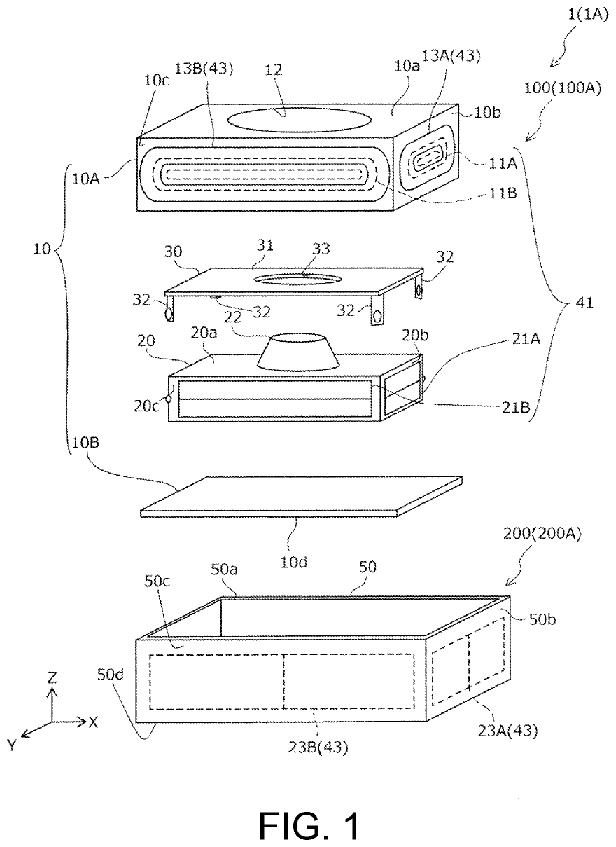

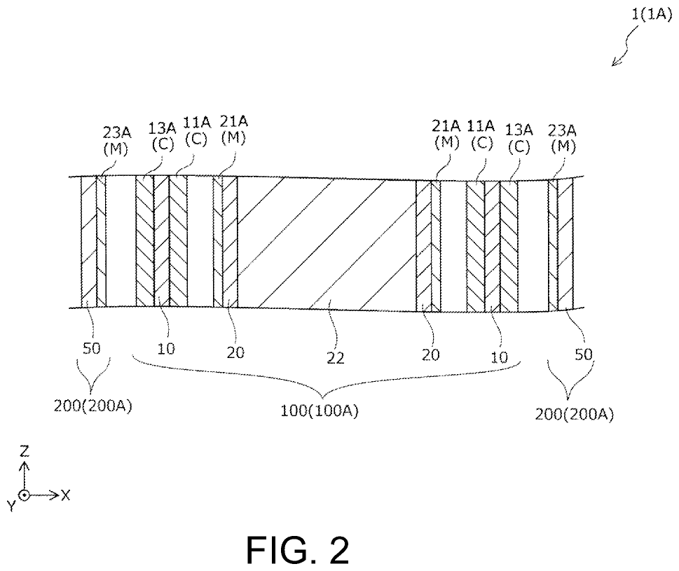

### [Embodiment 1] (FIGS. 1 and 2)

First, as an optical unit 1 of the disclosure, an optical unit 1A according to Embodiment 1 will be described with reference to FIGS. 1 and 2.

The optical unit 1A of the present embodiment may be preferably used in cameras, smartphones, or the like. This is because the optical unit 1A of the present embodiment is able to be compactly configured, enabling cameras or smartphones to be compactly configured. However, the optical unit 1A of the present embodiment is not limited to cameras or a smartphones, and is able to be used in a variety of devices without limiting its use in particular.

As shown in FIGS. 1 and 2, the optical unit 1A of the present embodiment includes a first movable body 20 including an optical module 22 provided with a lens or the like. Further, a second movable body 10 including a case 10A surrounding the first movable body 20 in peripheral directions intersecting the optical axis direction (Z-axis direction) of the optical module 22 and a bottom 10B capable of covering the case 10A from the −Z direction with the first movable body 20 housed in the case 10A is provided. Moreover, between the first movable body 20 and the second movable body 10, a gimbal mechanism 30 that swingably supports the first movable body 20 with respect to the second movable body 10 by means of a spring-like gimbal frame 31 is provided. Further, a swing mechanism 41 for swinging the first movable body 20 with respect to the second movable body 10 is provided.

A movable body 100 (a movable body 100A) is composed of the first movable body 20, the second movable body 10, the gimbal mechanism 30, the swing mechanism 41, and the like. Further, the optical unit 1A of the present embodiment includes a fixed body 200 (a fixed body 200A) that holds the movable body 100A inside an accommodator 50. The fixed body 200A surrounds the movable body 100A in the peripheral directions intersecting the optical axis direction (Z-axis direction).

The first movable body 20 has a substantially rectangular parallelepiped shape. The optical module 22 is held inside the first movable body 20 by an upper surface 20a, a lower surface 20d, side surfaces 20b on both sides in the X-axis direction, and side surfaces 20c on both sides in the Y-axis direction, and is arranged such that a lens protrudes from the upper surface 20a, which is a surface of the first movable body 20 in the +Z direction. Further, magnets 21A constituting the swing mechanism 41 are provided on the side surfaces 20b on both sides of the first movable body 20 in the X-axis direction. Magnets 21B constituting the swing mechanism 41 are provided on side surfaces 20c on both sides of the first movable body 20 in the Y-axis direction. The magnets 21A and the magnets 21B are two-pole magnetized magnets 21 in which the north poles and south poles are arranged in the Z-axis direction (optical axis direction).

The second movable body 10 has a substantially rectangular parallelepiped shape, in which the case 10A is composed of an upper surface 10a, the side surfaces 10b on both sides in the X-axis direction, and the side surfaces 10c on both sides in the Y-axis direction, and the bottom 10B is composed of a lower surface 10d. The upper surface 10a, which is the surface of the second movable body 10 in the +Z direction, is provided with a hole 12 through which the lens of the optical module 22 passes.

Further, coils 11A constituting the swing mechanism 41 are provided on the inner surfaces of the side surfaces 10b on both sides of the second movable body 10 in the X-axis direction. Coils 11B constituting the swing mechanism 41 are provided on the inner surfaces of the side surfaces 10c on both sides of the second movable body 10 in the Y-axis direction. The coils 11A are arranged at positions facing the magnets 21A, and the coils 11B are arranged at positions facing the magnets 21B. Further, coils 13A constituting a slide mechanism 43, which will be described later, are provided on the outer surfaces of the side surfaces 10b on both sides of the second movable body 10 in the X-axis direction. Coils 13B constituting the slide mechanisms 43 are provided on the outer surfaces of the side surfaces 10c on both sides of the second movable body 10 in the Y-axis direction.

The gimbal mechanism 30 includes the gimbal frame 31 having a circular hole 33 through which the optical module 22 passes and having a rectangular outer shape, and connecters 32 for connecting the first movable body 20 and the second movable body 10. The connecters 32 are provided at the four corners of the rectangular gimbal frame 31, of which two diagonal connecters 32 are swingably connected to the first movable body 20 and another two diagonal connecters 32 are swingably connected to the second movable body 10.

The swing mechanism 41 includes a pitching axis swing mechanism including the coils 11A and the magnets 21A, and a yawing axis swing mechanism including the coils 11B and the magnets 21B. Specifically, a total of two coils 11A and a total of two magnets 21A, one on each side of the optical unit 1A in the Y-axis direction, are provided as a pitching axis swing mechanism, and a total of two coils 11B and a total of two magnets 21B, one on each side of the optical unit 1A in the Y-axis direction, are provided as a yawing axis swing mechanism. However, the disclosure is not limited to such a configuration. The pitching axis swing mechanism may be provided with one coil 11A and one magnet 21A, and the yawing axis swing mechanism may be provided with one coil 11B and one magnet 21B. A configuration that includes only one of the pitching axis swing mechanism and the yawing axis swing mechanism is possible.

As described above, both the magnets 21A and the magnets 21B are provided by arranging the north poles and south poles in the Z-axis direction, and the first movable body 20 is engaged with the second movable body 10 by the gimbal mechanism 30 at four corners. Therefore, by driving the pitching axis swing mechanism composed of the coils 11A and the magnets 21A, a force is applied to the magnets 21A in the Z-axis direction, and the first movable body 20 tilts with respect to the second movable body 10 with the Y-axis direction as a rotation axis. On the other hand, by driving the yawing axis swing mechanism composed of the coils 11B and the magnets 21B, a force is applied to the magnets 21B in the Z-axis direction, and the first movable body 20 tilts with respect to the second movable body 10 with the X-axis direction as a rotation axis.

The accommodator 50 has an upper surface 50a open in the +Z direction, and has a substantially rectangular parallelepiped cup shape by side surfaces 50b on both sides in the X-axis direction, side surfaces 50c on both sides in the Y-axis direction, and a lower surface 50d in the −Z direction. However, as long as the lens provided on the optical module 22 is not shielded from light, the upper surface 50a may not need to be open in the +Z direction. Further, magnets 23A constituting the slide mechanism 43 are provided on the inner surfaces of the side surfaces 50b on both sides in the X-axis direction. Magnets 23B constituting the slide mechanism 43 are provided on the inner surfaces of the side surfaces 50c on both sides in the Y-axis direction. The magnets 23A are arranged at positions facing the coils 13A provided on the second movable body 10, and the magnets 23B are arranged at positions facing the coils 13B provided on the second movable body 10.

Here, the magnets 23A are two-pole magnetized magnets 21 in which the north poles and south poles are arranged in the Y-axis direction. Therefore, when a current is passed through the coils 13A, a force is applied to the magnets 23A in the Y-axis direction. On the other hand, the magnets 23B are two-pole magnetized magnets 21 in which the north poles and south poles are arranged in the X-axis direction. Therefore, when a current is passed through the coils 13B, a force is applied to the magnets 23B in the X-axis direction. The accommodator 50 is provided with a guide mechanism (not shown); the movable body 100A shifts in the Y-axis direction with respect to the fixed body 200A by passing a current through the coils 13A, and the movable body 100A shifts in the X-axis direction with respect to the fixed body 200A by passing a current through the coils 13B.

Here, to summarize once, the optical unit 1A of the present embodiment includes the movable body 100 including the optical module 22, and the fixed body 200 surrounding the movable body 100 in the peripheral directions intersecting the optical axis direction (Z-axis direction) of the optical module 22. Then, the swing mechanism 41 and the gimbal mechanism 30 serve as correction mechanisms that correct the optical axis direction by changing the arrangement of the movable body 100 with respect to the fixed body 200. Further, the slide mechanism 43, together with the guide mechanism (not shown) and the like, also serves as a correction mechanism. Specifically, as the correction mechanisms, the swing mechanism 41 serves as a tilt mechanism that swingably supports the movable body 100 with respect to the fixed body 200 with the direction (X-axis direction and Y-axis direction) intersecting the optical axis direction as rotation axes, and the slide mechanism 43 serves as a shift mechanism that movably supports the movable body 100 with respect to the fixed body 200 in the direction (X-axis direction and Y-axis direction) intersecting the optical axis direction.

As described above, as the correction mechanisms, the optical unit 1A of the present embodiment includes a tilt mechanism that swingably supports the movable body 100 with respect to the fixed body 200 with the direction intersecting the optical axis direction as a rotation axis, and a shift mechanism that movably supports the movable body 100 with respect to the fixed body 200 in the direction intersecting the optical axis direction. Therefore, by combining two types of correction mechanisms, the optical unit 1A of the present embodiment is able to increase the amount of correction in the optical axis direction while keeping the optical unit 1 small.

Here, the optical unit 1A of the present embodiment is configured such that the correction range of the arrangement of the movable body 100 with respect to the fixed body 200 in the optical axis direction of the optical module 22 by the tilt mechanism is larger than the correction range of the arrangement of the movable body 100 with respect to the fixed body 200 in the optical axis direction of the optical module 22 by the shift mechanism. With such a configuration, in the optical unit 1A of the present embodiment, the tilt mechanism that easily increases the amount of correction is configured as the main correction mechanism and the shift mechanism that makes it difficult to increase the amount of correction is configured as the sub correction mechanism, such that the amount of correction in the optical axis direction is efficiently increased. In the optical unit 1A of the present embodiment, for example, when correcting the optical axis direction of 5°, the correction range by the tilt mechanism is set to 4°, and the correction range by the shift mechanism is set to a movement amount equivalent to 1°.

Further, in the optical unit 1A of the present embodiment, the swing mechanism 41 and the slide mechanism 43 are both drive mechanisms including coils C and magnets M. As described above, it is desirable that at least one of the tilt mechanism and the shift mechanism is provided with a drive mechanism including the coils C and the magnets M. This is because such as configuration allows at least one drive mechanism of the tilt mechanism and the shift mechanism to be a simple configuration including the coils C and the magnets M.

Further, as shown in FIG. 2, respect to the second movable body 10, the optical unit 1A of the present embodiment are provided with the coils C (the coils 11A and the coils 11B) of the coils C and the magnets M constituting the swing mechanism 41 and the coil Cs (the coils 13A and the coils 13B) of the coils C and the magnets M constituting the slide mechanism 43. This is because when the magnets M are arranged against each other with respect to the second movable body 10, the magnetic force of one magnet M arranged on the second movable body 10 may affect the other magnet M arranged on the second movable body 10.

In other words, in the optical unit 1A of the present embodiment, both the tilt mechanism and the shift mechanism include a drive mechanism including the coils C and the magnets M, and are arranged at positions where the magnets M of the tilt mechanism and the magnets M of the shift mechanism do not interfere with each other. With such a configuration, the optical unit 1A of the present embodiment prevents the magnets M of the tilt mechanism and the magnets M of the shift mechanism from interfering with each other and causing the correction mechanisms to malfunction.

Here, at least one of the tilt mechanism and the shift mechanism may be configured such that the movable body 100 includes the magnets M and the fixed body 200 includes the coils C. In this way, coil wirings can be simplified by configuring the immovable fixed body 200 to include the coils C.

However, as in the shift mechanism of the optical unit 1A of the present embodiment, the configuration may be such that at least one of the tilt mechanism and the shift mechanism has the coils C in the movable body 100 and the magnets M in the fixed body 200. This is because with such a configuration, even in a configuration in which it is difficult to have the magnets M in the movable body 100 and the coils C in the fixed body 200, it is possible to increase the amount of correction in the optical axis direction while keeping the optical unit 1 small.

As in the optical unit 1A of the present embodiment, the configuration may be such that the shift mechanism, together with the tilt mechanism, moves the movable body 100 with respect to the fixed body 200 in the direction intersecting the optical axis direction. With such a configuration, the optical unit (equivalent to the optical unit 1A of the present embodiment) having the tilt mechanism and the movable body 100 is able to be shifted to correct the optical axis direction.

However, the tilt mechanism, together with the shift mechanism, may swing the movable body 100 with respect to the fixed body 200 in the directions intersecting the optical axis direction as rotation axes. With such a configuration, the optical unit having the shift mechanism and the movable body 100 is able to be tilted to correct the optical axis direction.

The optical unit 1A of the present embodiment includes the coils 13A and the magnets 23A that are able to slide the movable body 100 with respect to the fixed body 200 in the Y-axis direction and the coils 13B and the magnets 23B that are able to slide the movable body 100 with respect to the fixed body 200 in the axial direction X as a shift mechanism. However, the disclosure is not limited such a configuration. As a shift mechanism, a configuration in which the movable body 100 is able to be slid with respect to the fixed body 200 in only one of the X-axis direction and the Y-axis direction is possible.

Further, in the optical unit 1A of the present embodiment, two pairs of the coil 13A and magnet 23A and two pairs of the coil 13B and magnet 23B are included as the shift mechanism. However, the configuration is not limited thereto; a configuration including one pair of the coil 13A and magnet 23A and one pair of the coil 13B and magnet 23B as the shift mechanism is possible. Further, in the optical unit 1A of the present embodiment, two pairs of the coil 11A and magnet 21A and two pairs of the coil 11B and magnet 21B are included as the tilt mechanism. However, the configuration is not limited thereto; a configuration including one pair of the coil 11A and magnet 21A and one pair of the coil 11B and magnet 21B as the tilt mechanism is possible.

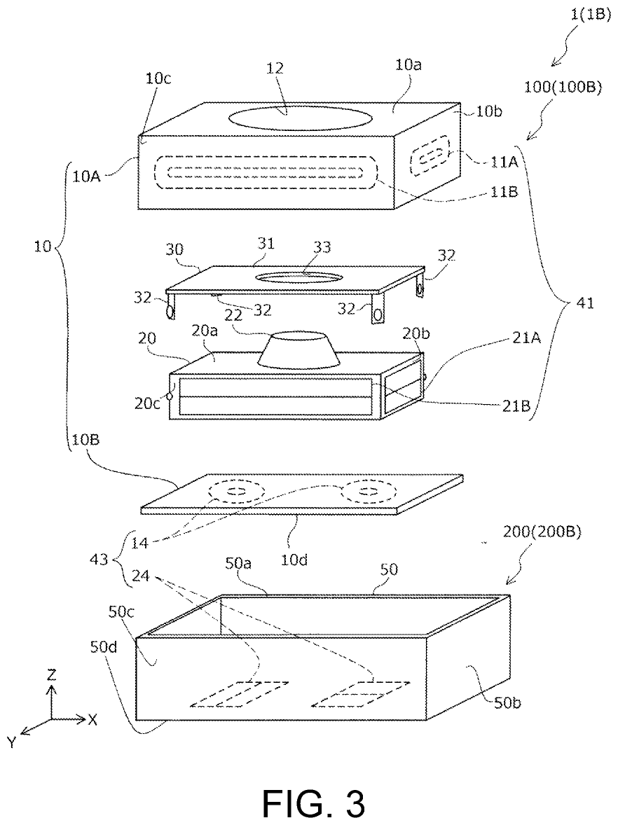

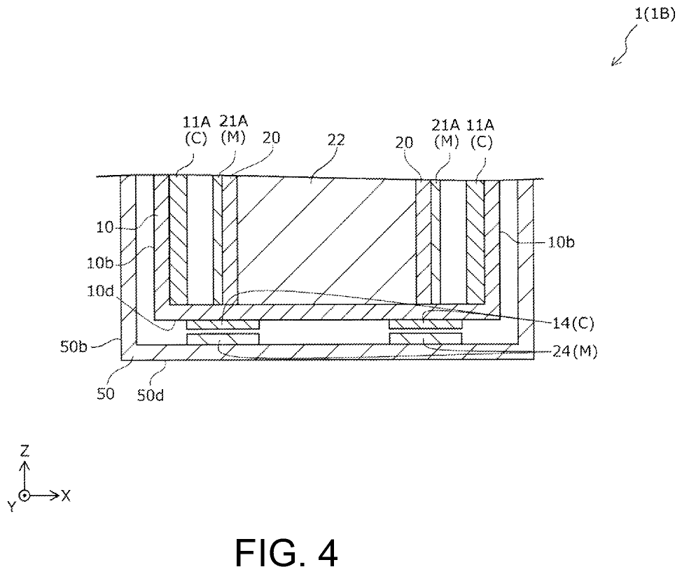

### [Embodiment 2] (FIGS. 3 and 4)

Next, the optical unit 1B of Embodiment 2 will be described with reference to FIGS. 3 and 4. Here, FIG. 3 is an exploded perspective view of an optical unit 1B according to Embodiment 2 of the disclosure, and is corresponding to the optical unit 1A of Embodiment 1 in FIG. 1. Moreover, FIG. 4 is a side sectional view of the optical unit 1B according to Embodiment 2 of the disclosure, and is a view corresponding to the optical unit 1A of Embodiment 1 in FIG. 2. The components common to those in Embodiment 1 are indicated by the same reference numerals, and detailed description thereof will be omitted. The optical unit 1B of the present embodiment has the same configuration as the optical unit 1A of Embodiment 1 except for the configuration of the portions described below. Therefore, it has the same technical features as the optical unit 1A of Embodiment 1 except for the portions described below.

As shown in FIGS. 1 and 2, the optical unit 1A of Embodiment 1 has a configuration in which the shift mechanism (the slide mechanism 43) is arranged in the peripheral directions of the movable body 100 (the movable body 100A). On the other hand, as shown in FIGS. 3 and 4, the optical unit 1B of the present embodiment has a configuration in which the shift mechanism (the slide mechanism 43) is arranged at positions overlapping with the movable body 100 (a movable body 100B) in the optical axis direction, not in the peripheral directions of the movable body 100 (the movable body 100B).

Specifically, the optical unit 1B of the present embodiment includes coils 14 on the lower surface 10d of the bottom 10B, and magnets 24 on the lower surface 50d of the accommodator 50. Two coils 14 and two magnets 24 are provided; one magnet 24 has the north poles and south poles arranged in the X-axis direction, and the other magnet 24 has the north poles and south poles arranged in the Y-axis direction. Therefore, by adjusting the currents passing through the two coils 14, the movable body 100B is able to be shifted with respect to a fixed body 200B in both the X-axis direction and the Y-axis direction. However, the configuration is not limited thereto; the configuration may be such that the movable body 100B is able to shift with respect to the fixed body 200B only in either the X-axis direction or the Y-axis direction.

Since the optical unit 1A of Embodiment 1 has a configuration in which the shift mechanism is arranged in the peripheral directions of the movable body 100, increase in the size of the optical unit 1 in the optical axis direction can be suppressed. On the other hand, since the optical unit 1B of the present embodiment has a configuration in which the shift mechanism is arranged at positions overlapping with the movable body 100 in the optical axis direction, increase in size of the optical unit 1 in the peripheral directions can be suppressed.

According to this aspect, the correction mechanisms include a tilt mechanism that swingably supports the movable body with respect to the fixed body with the direction intersecting the optical axis direction as a rotation axis, and a shift mechanism that movably supports the movable body in the direction intersecting the optical axis direction with respect to the fixed body. Therefore, by combining two types of correction mechanisms, the amount of correction in the optical axis direction can be increased while keeping the optical unit small.

The optical unit of the disclosure may be configured such that a correction range of the arrangement of the movable body with respect to the fixed body in the optical axis direction of the optical module by the tilt mechanism is wider than a correction range of the arrangement of the movable body with respect to the fixed body in the optical axis direction of the optical module by the shift mechanism. With such a configuration, the tilt mechanism that makes it easy to increase the amount of correction may be configured as the main correction mechanism, and the shift mechanism that makes it difficult to increase the amount of correction may be configured as the sub correction mechanism, such that the amount of correction in the optical axis direction can be efficiently increase.

The optical unit of the disclosure may be configured such that at least one of the tilt mechanism and the shift mechanism includes a drive mechanism including a coil and a magnet. With such a configuration, at least one drive mechanism of the tilt mechanism and the shift mechanism can be a simple configuration including a coil and a magnet.

The optical unit of the disclosure may be configured such that both the tilt mechanism and the shift mechanism include a drive mechanism including a coil and a magnet, and the magnet of the tilt mechanism and the magnet of the shift mechanism are located at positions so as not to interfere with each other. With such a configuration, it is possible to prevent the magnet of the tilt mechanism and the magnet of the shift mechanism from interfering with each other and causing the correction mechanisms to malfunction.

The optical unit of the disclosure maybe configured such that at least one of the tilt mechanism and the shift mechanism includes the magnet in the movable body and the coil in the fixed body. In this way, the coil wiring can be simplified by forming the coil in the immovable fixed body.

The optical unit of the disclosure may be configured such that at least one of the tilt mechanism and the shift mechanism includes the coil in the movable body and the magnet in the fixed body. With such a configuration, even in a configuration in which it is difficult to have a magnet in the movable body and a coil in the fixed body, it is possible to increase the amount of correction in the optical axis direction while keeping the optical unit small.

The optical unit of the disclosure may be configured such that the shift mechanism, together with the tilt mechanism, moves the movable body with respect to the fixed body in the direction intersecting the optical axis direction. With such a configuration, the optical unit having the tilt mechanism and the movable body is able to be shifted to correct the optical axis direction.

The optical unit of the disclosure may be configured such that the tilt mechanism, together with the shift mechanism, swings the movable body with respect to the fixed body with the direction intersecting the optical axis direction as a rotation axis. With such a configuration, the optical unit having the shift mechanism and the movable body is able to be tilted to correct the optical axis direction.

In the optical unit of the disclosure, it is possible to increase the amount of correction in the optical axis direction while keeping a small size in the optical unit including a movable body including an optical module, a fixed body, and correction mechanisms that correct the optical axis direction by changing the arrangement of the fixed body and the movable body with respect to the fixed body.

The disclosure is not limited to the above-described embodiment, and can be realized with various configurations within a range not deviating from the gist thereof. For example, the technical features in the embodiments corresponding to the technical features in each form described in the summary of the disclosure can be appropriately replaced or combined to solve some or all of the above-mentioned problems, or one of the above-mentioned effects. Further, if the technical feature is not described as essential in the specification, it can be deleted as appropriate.

What is claimed is:

1. An optical unit comprising:
a movable body comprising an optical module,
a fixed body surrounding the movable body in peripheral directions intersecting an optical axis direction of the optical module, and
correction mechanisms that correct an optical axis direction by changing an arrangement of the movable body with respect to the fixed body, wherein
the correction mechanisms comprise:
a tilt mechanism that swingably supports the movable body with respect to the fixed body with a direction intersecting the optical axis direction as a rotation axis, and
a shift mechanism that movably supports the movable body with respect to the fixed body in the direction intersecting the optical axis direction.

2. The optical unit according to claim 1, wherein
a correction range of the arrangement of the movable body with respect to the fixed body in the optical axis direction of the optical module by the tilt mechanism is wider than a correction range of the arrangement of the movable body with respect to the fixed body in the optical axis direction of the optical module by the shift mechanism.

3. The optical unit according to claim 1, wherein
at least one of the tilt mechanism and the shift mechanism comprises a drive mechanism comprising a coil and a magnet.

4. The optical unit according to claim 1, wherein
both the tilt mechanism and the shift mechanism comprise a drive mechanism comprising a coil and a magnet, and
the magnet of the tilt mechanism and the magnet of the shift mechanism are located at positions so as not to interfere with each other.

5. The optical unit according to claim 3, wherein
at least one of the tilt mechanism and the shift mechanism comprises a magnet in the movable body and a coil in the fixed body.

6. The optical unit according to claim 3, wherein
at least one of the tilt mechanism and the shift mechanism comprises a coil in the movable body and a magnet in the fixed body.

7. The optical unit according to claim 1, wherein
the shift mechanism, together with the tilt mechanism, moves the movable body with respect to the fixed body in the direction intersecting the optical axis direction.

8. The optical unit according to claim 1, wherein
the tilt mechanism, together with the shift mechanism, swings the movable body with respect to the fixed body in the direction intersecting the optical axis direction as a rotation axe.
